(19) United States
(12) Patent Application Publication
(10) Pub. No.: US 2025/0080436 A1
(43) Pub. Date: Mar. 6, 2025

(54) SYSTEM AND METHOD FOR NETWORK POLICY SIMULATION

(71) Applicant: Cisco Technology, Inc., San Jose, CA (US)

(72) Inventors: Sunil Kumar Gupta, Milpitas, CA (US); Navindra Yadav, Cupertino, CA (US); Michael Standish Watts, Mill Valley, CA (US); Ali Parandehgheibi, Sunnyvale, CA (US); Shashidhar Gandham, Fremont, CA (US); Ashutosh Kulshreshtha, Fremont, CA (US); Khawar Deen, Sunnyvale, CA (US)

(21) Appl. No.: 18/949,393

(22) Filed: Nov. 15, 2024

Related U.S. Application Data
(63) Continuation of application No. 17/819,888, filed on Aug. 15, 2022.
Application No. 17/819,888 is a continuation of application No. 15/045,205, filed on Feb. 16, 2016, now abandoned.
(60) Provisional application No. 62/171,899, filed on Jun. 5, 2015.

(51) Int. Cl. H04L 43/045; G06F 3/0482; G06F 3/04842; G06F 3/04847; G06F 9/455; G06F 16/11; G06F 16/13; G06F 16/16; G06F 16/17; G06F 16/174; G06F 16/23; G06F 16/2457; G06F 16/248; G06F 16/28; G06F 16/29; G06F 16/9535; G06F 21/53; G06F 21/55; G06F 21/56; G06N 20/00; G06N 99/00; G06T 11/20; H04J 3/06; H04J 3/14; H04L 1/24; H04L 7/10; H04L 9/08; H04L 9/32; H04L 9/40; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0852; H04L 43/0864; H04L 43/0876; H04L 43/0882; H04L 43/0888; H04L 43/10; H04L 43/106; H04L 43/12; H04L 43/16; H04L 45/00; H04L 45/302; H04L 45/50; H04L 45/74; H04L 47/11; H04L 47/20; H04L 47/2441; H04L 47/2483; H04L 47/28; H04L 47/31; H04L 47/32; H04L 61/5007; H04L 67/01; H04L 67/10; H04L 67/1001; H04L 67/12; H04L 67/50; H04L 67/51; H04L 67/75; H04L 69/16; H04L 69/22; H04W 72/54; H04W 84/18

(52) U.S. Cl. CPC H04L 43/045; G06F 3/0482; G06F 3/04842; G06F 3/04847; G06F 9/45558; G06F 16/122; G06F 16/137; G06F 16/162; G06F 16/17; G06F 16/173; G06F 16/174; G06F 16/1744; G06F 16/1748; G06F 16/2322; G06F 16/235; G06F 16/2365; G06F 16/24578; G06F 16/248; G06F 16/285; G06F 16/288; G06F 16/29; G06F 16/9535; G06F 21/53; G06F 21/552; G06F 21/556; G06F 21/566; G06N 20/00; G06N 99/00; G06T 11/206; H04J 3/0661; H04J 3/14; H04L 1/242; H04L 7/10; H04L 9/0866; H04L 9/3239; H04L 9/3242; H04L 41/046; H04L 41/0668; H04L 41/0803; H04L 41/0806; H04L 41/0816; H04L 41/0893; H04L 41/12; H04L 41/16; H04L 41/22; H04L 43/02; H04L 43/026; H04L 43/04; H04L 43/062; H04L 43/08; H04L 43/0805; H04L 43/0811; H04L 43/0829; H04L 43/0841; H04L 43/0858; H04L 43/0864; H04L 43/0876; H04L 43/0882; H04L 43/0888; H04L 43/10; H04L 43/106; H04L 43/12; H04L 43/16; H04L 45/306; H04L 45/38; H04L 45/46; H04L 45/507; H04L 45/66; H04L 45/74; H04L 47/11; H04L 47/20; H04L 47/2441; H04L 47/2483; H04L 47/28; H04L 47/31; H04L 47/32; H04L 61/5007; H04L 63/0227; H04L 63/0263; H04L 63/06; H04L 63/0876; H04L 63/1408; H04L 63/1416; H04L 63/1425; H04L 63/1433; H04L 63/1441; H04L 63/145; H04L 63/1458; H04L 63/1466; H04L 63/16; H04L 63/20; H04L 67/01; H04L 67/10; H04L 67/1001; H04L 67/12; H04L 67/51; H04L 67/75; H04L 69/16; H04L 69/22; H04W 72/54; H04W 84/18; G06F 2009/4557; G06F 2009/45587; G06F 2009/45591; G06F 2009/45595; G06F 2221/033; G06F 2221/2101; G06F 2221/2105; G06F 2221/2111; G06F 2221/2115; G06F 2221/2145; H04L 67/535

(57) ABSTRACT

This disclosure generally relate to a method and system for network policy simulation in a distributed computing system. The present technology relates techniques that enable simulation of a new network policy with regard to its effects on the network data flow. By enabling a simulation data flow that is parallel and independent from the regular data flow, the present technology can provide optimized network security management with improved efficiency.

### CROSS-REFERENCE TO RELATED APPLICATION

This application is a continuation of U.S. application Ser. No. 17/819,888, filed Aug. 15, 2022, entitled “SYSTEM AND METHOD FOR NETWORK POLICY SIMULATION,” which, in turn, is a continuation of U.S. application Ser. No. 15/045,205, filed Feb. 16, 2016, entitled “SYSTEM AND METHOD FOR NETWORK POLICY SIMULATION,” which, in turn, claims priority to U.S. Provisional Application 62/171,899, titled “System for Monitoring and Managing Datacenters” and filed Jun. 5, 2015, all of which are expressly incorporated by reference in their entireties.

### TECHNICAL FIELD

The disclosure relates generally to computer networks. More specifically, certain embodiments of the technology relate to a method and system for network policy simulation in a distributed computing system.

### BACKGROUND

With the growing demand of clustered storage and computing, network security policy management has become an important aspect for modern datacenters. Network security policies define network architecture, govern data access and safeguard the system integrity of datacenters.

It remains a challenge to manually manage the large number of network security policies. Even small datacenters could potentially implement hundreds or thousands of policies. Further, various changes to the network (e.g., adding or removing a security policy, modifying one or more endpoint groups) can result in network latency or even network failures.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates a schematic block diagram of a network traffic monitoring system for a network, according to some embodiments;

FIG. 2 illustrates an example of a network environment, according to some embodiments;

FIG. 3 illustrates an example of a policy table for various endpoint groups, according to some embodiments;

FIG. 4 is a flow diagram illustrating an example of a process for a network traffic monitoring system, according to some embodiments;

FIG. 5 is a flow diagram illustrating an example of another process for a network traffic monitoring system, according to some embodiments; and

FIGS. 6A and 6B illustrate a computing platform of a computing device, according to some embodiments.

### DESCRIPTION OF EXAMPLE EMBODIMENTS

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

### Overview

Aspects of the present technology relate to techniques that enable simulation of a new network policy and/or changes to endpoint group (EPG) membership_with regard to its effects on network data flow. By enabling a simulation data flow that is parallel and independent from the regular data flow, the present technology can provide optimized network security management with improved efficiency.

In accordance with one aspect of the present disclosure, a computer-implemented method is provided. The method includes receiving a network traffic from a first endpoint group of a network destined for a second endpoint group of the network, capturing first network flow data between the first endpoint group and the second endpoint group based at least in part by enforcing a first network policy of the network with respect to the network traffic, receiving a request to simulate enforcement of a second network policy between the first endpoint group and the second endpoint group, determining second network flow data between the first endpoint group and the second endpoint group by simulating enforcement of the second network policy with respect to the network traffic, and providing an indication whether to enforce the second network policy based at least in part on the second network flow data.

According to some embodiments, the present technology can enable a computer-implemented method that further includes receiving aggregate network flow data from a plurality of sensors of the network, the plurality of sensors including at least a first sensor of a physical switch of the network, a second sensor of a hypervisor associated with the physical switch, a third sensor of a virtual machine associated with the hypervisor, determining, based at least in part on the aggregate network flow data, a dependency map of an application executing in the network, the dependency map indicating a pattern of network traffic associated with the application, determining, based at least in part on the dependency map, at least one network policy for the network, and storing the at least one network policy in a policy table

In accordance with another aspect of the present disclosure, a non-transitory computer-readable storage medium storing instructions is provided, the instructions which, when executed by a processor, cause the processor to perform operations including, receive a network traffic from a first endpoint group of a network destined for a second endpoint group of the network, capture first network flow data between the first endpoint group and the second endpoint group based at least in part by enforcing a first network policy of the network with respect to the network traffic, receive a request to simulate enforcement of a second network policy between the first endpoint group and the second endpoint group, determine second network flow data between the first endpoint group and the second endpoint group by simulating enforcement of the second network policy with respect to the network traffic, and provide an indication whether to enforce the second network policy based at least in part on the second network flow data.

Although many of the examples herein are described with reference to the network security policy, it should be understood that these are only examples and the present technology is not limited in this regard. Rather, any network rules or policies that provide communication protocols for a distributed computing system may be used.

Additionally, even though the present discussion uses a sensor as an example of a network-monitoring device, the present technology is applicable to other controller or device that is capable of review, record and report network data communication between various end groups.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### DETAILED DESCRIPTION

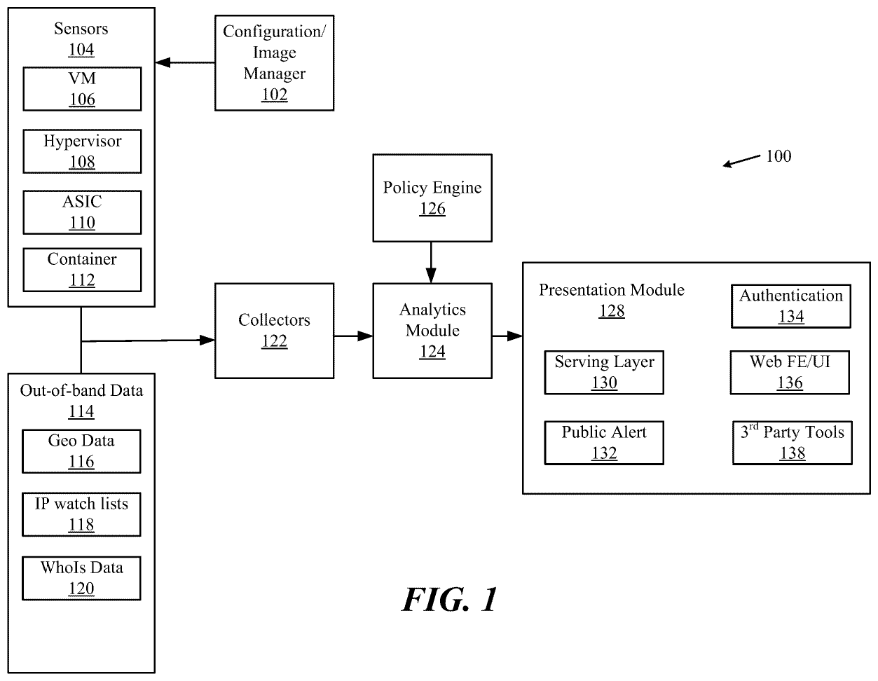

FIG. 1 illustrates a schematic block diagram of a network traffic monitoring system for a network, according to some embodiments. It should be appreciated that the system topology in FIG. 1 is an example, and any numbers of computing devices such as sensors, collectors, and network components may be included in the system of FIG. 1.

FIG. 1 illustrates a network traffic monitoring system 100, which can include, for example, configuration image imaginer 102, sensors 104, collectors 122, analytics module 124, policy engine 126 and presentation module 128.

Configuration and image manager 102 can configure and manage sensors 104. For example, when a new virtual machine is instantiated or when an existing virtual machine is migrated, configuration and image manager 102 can provision and configure a new sensor on the virtual machine. According to some embodiments, configuration and image manager 102 can monitor the physical status or heathy of sensors 104. For example, configuration and image manager 102 might request status updates or initiate tests. According to some embodiments, configuration and image manager 102 also manages and provisions virtual machines.

According to some embodiments, configuration and image manager 102 can verify and validate sensors 104. For example, sensors 104 can be provisioned with a unique ID that is generated using a one-way hash function of its basic input/output system (BIOS) universally unique identifier (UUID) and a secret key stored on configuration and image manager 102. This unique ID can be a large number that is difficult for an imposter sensor to guess. According to some embodiments, configuration and image manager 102 can keep sensors 104 up to date by installing new versions of their software and applying patches. Configuration and image manager 102 can get these updates from a local source or automatically from a remote source via internet.

Sensors 104 can be associated with each node and component of a data center (e.g., virtual machine, hypervisor, slice, blade, switch, router, gateway, etc.). Sensors 104 can monitor communications to and from the component, report on environmental data related to the component (e.g., component IDs, statuses, etc.), and perform actions related to the component (e.g., shut down a process, block ports, redirect traffic, etc.). Sensors 104 can send their records over a high-bandwidth connection to the collectors 122 for storage.

Sensors 104 can comprise software codes (e.g., running on virtual machine 106, container 112, or hypervisor 108), an application-specific integrated circuit (ASIC 110, e.g., a component of a switch, gateway, router, or standalone packet monitor), or an independent unit (e.g., a device connected to a switch's monitoring port or a device connected in series along a main trunk of a datacenter). For clarity and simplicity in this description, the term “component” is used to denote a component of the network (i.e., a process, module, slice, blade, hypervisor, machine, switch, router, gateway, etc.). It should be understood that various software and hardware configurations can be used as sensors 104. Sensors 104 can be lightweight, minimally impeding normal traffic and compute resources in a datacenter. Software sensors 104 can “sniff” packets being sent over its host network interface card (NIC) or individual processes can be configured to report traffic to sensors 104.

According to some embodiments, sensors 104 reside on every virtual machine, hypervisor, switch, etc. This layered sensor structure allows for granular packet statistics and data collection at each hop of data transmission. In some embodiments, sensors 104 are not installed in certain places. For example, in a shared hosting environment, customers may have exclusive control of VMs, thus preventing network administrators from installing a sensor on those client-specific VMs.

As sensors 104 capture communications, they can continuously send network traffic flow data to collectors 122. The network traffic flow data can relate to a packet, collection of packets, flow, group of flows, open ports, port knocks, etc. The network traffic flow data can also include other details such as the VM bios ID, sensor ID, associated process ID, associated process name, process user name, sensor private key, geo-location of sensor, environmental details, etc. The network traffic flow data can comprise data describing the communication on all layers of the OSI model. For example, the network traffic flow data can include Ethernet signal strength, source/destination MAC address, source/destination IP address, protocol, port number, encryption data, requesting process, a sample packet, etc.

Sensors 104 can preprocess network traffic flow data before sending. For example, sensors 104 can remove extraneous or duplicative data or create a summary of the data (e.g., latency, packets and bytes sent per traffic flow, flagging abnormal activity, etc.). According to some embodiments, sensors 104 are configured to selectively capture certain types of connection information while disregarding the rest. Further, as it can be overwhelming for a system to capture every packet, sensors can be configured to capture only a representative sample of packets (for example, every 1,000ₜₕ packet).

According to some embodiments, sensors 104 can perform various actions with regard to the associated network component. For example, a sensor installed on a VM can close, quarantine, restart, or throttle a process executing on the VM. Sensors 104 can create and enforce policies (e.g., block access to ports, protocols, or addresses). According to some embodiments, sensors 104 receive instructions to perform such actions; alternatively, sensors 104 can act autonomously without external direction.

Sensors 104 can send network traffic flow data to one or more collectors 122. Sensors 104 can be assigned to send network traffic flow data to a primary collector and a secondary collector. In some embodiments, sensors 104 are not assigned a collector, but determine an optimal collector through a discovery process. Sensors 104 can change a destination for the report if its environment changes. For example, if a certain collector experiences failure or if a sensor is migrated to a new location that is close to a different collector. According to some embodiments, sensors 104 send different network traffic flow data to different collectors. For example, sensors 104 can send a first report related to one type of process to a first collector, and send a second report related to another type of process to a second collector.

Collectors 122 can be any type of storage medium that can serve as a repository for the data recorded by the sensors. According to some embodiments, collectors 122 are directly connected to the top of rack (TOR) switch; alternatively, collectors 122 can be located near the end of row or elsewhere on or off premises. The placement of collectors 122 can be optimized according to various priorities such as network capacity, cost, and system responsiveness. According to some embodiments, data storage of collectors 122 is located in an in-memory database such as dash DB by IBM. This approach benefits from rapid random access speeds that typically are required for analytics software. Alternatively, collectors 122 can utilize solid state drives, disk drives, magnetic tape drives, or a combination of the foregoing according to cost, responsiveness, and size requirements. Collectors 122 can utilize various database structures such as a normalized relational database or NoSQL database.

According to some embodiments, collectors 122 serve as network storage for network traffic monitoring system 100. Additionally, collectors 122 can organize, summarize, and preprocess the collected data. For example, collectors 122 can tabulate how often packets of certain sizes or types are transmitted from different virtual machines. Collectors 122 can also characterize the traffic flows going to and from various network components. According to some embodiments, collectors 122 can match packets based on sequence numbers, thus identifying traffic flows as well as connection links.

According to some embodiments, collectors 122 flag anomalous data. Because it would be inefficient to retain all data indefinitely, collectors 122 can routinely replace detailed network traffic flow data with consolidated summaries. In this manner, collectors 122 can retain a complete dataset describing one period (e.g., the past minute), with a smaller report of another period (e.g., the previous), and progressively consolidated network traffic flow data of other times (day, week, month, year, etc.). By organizing, summarizing, and preprocessing the data, collectors 122 can help network traffic monitoring system 100 scale efficiently. Although collectors 122 are generally herein referred to as a plural noun, a single machine or cluster of machines are contemplated to be sufficient, especially for smaller datacenters. In some embodiments, collectors 122 serve as sensors 104 as well.

According to some embodiments, collectors 122 receive data that does not come from sensors 104. For example, collectors 122 can receive out-of-band data 114 that includes, for example, geolocation data 116, IP watch lists 118, and WhoIs data 120. Additional out-of-band data can include power status, temperature data, etc.

Configuration and image manager 102 can configure and manage sensors 104. When a new virtual machine is instantiated or when an existing one is migrated, configuration and image manager 102 can provision and configure a new sensor on the machine. In some embodiments configuration and image manager 102 can monitor the health of sensors 104. For example, configuration and image manager 102 might request status updates or initiate tests. In some embodiments, configuration and image manager 102 also manages and provisions virtual machines.

Analytics module 124 can, via a high bandwidth connection, process the data stored in various collectors 122. Analytics module 124 can accomplish various tasks in its analysis, some of which are herein disclosed. According to some embodiments, network traffic monitoring system 100 can utilize analytics module 124 to automatically determine network topology. Using data provided from sensors 104, analytics module 124 can determine what type of devices exist on the network (brand and model of switches, gateways, machines, etc.), where they are physically located (e.g., latitude and longitude, building, datacenter, room, row, rack, machine, etc.), how they are interconnected (10 Gb Ethernet, fiber-optic, etc.), and what the strength of each connection is (bandwidth, latency, etc.). Automatically determining the network topology can facilitate integrating of network traffic monitoring system 100 within an already established datacenter. Furthermore, analytics module 124 can detect changes of network topology without the needed of further configuration.

Analytics module 124 can determine dependencies of components within the network. For example, if component A routinely sends data to component B, but component B never sends data to component A, then analytics module 124 can determine that component B is dependent on component A, but A is likely not dependent on component B. If, however, component B also sends data to component A, then they are likely interdependent. These components can be processes, virtual machines, hypervisors, VLANs, etc. Once analytics module 124 has determined component dependencies, it can then form a component (“application”) dependency map. This map can be instructive when analytics module 124 attempts to determine the root cause of a failure (because failure of one component can cascade and cause failure of its dependent components) or when analytics module 124 attempts to predict what will happen if a component is taken offline. Additionally, analytics module 124 can associate edges of an application dependency map with expected latency, bandwidth, etc. for that individual edge.

Analytics module 124 can establish patterns and norms for component behavior. For example, it can determine that certain processes (when functioning normally) will only send a certain amount of traffic to a certain VM using a small set of ports. Analytics module 124 can establish these norms by analyzing individual components or by analyzing data coming from similar components (e.g., VMs with similar configurations). Similarly, analytics module 124 can determine expectations for network operations. For example, it can determine the expected latency between two components, the expected throughput of a component, response times of a component, typical packet sizes, traffic flow signatures, etc. In some embodiments, analytics module 124 can combine its dependency map with pattern analysis to create reaction expectations. For example, if traffic increases with one component, other components may predictably increase traffic in response (or latency, compute time, etc.).

According to some embodiments, analytics module 124 uses machine learning techniques to identify which patterns are policy-compliant or unwanted or harmful. For example, a network administrator can indicate network states corresponding to an attack and network states corresponding to normal operation. Analytics module 124 can then analyze the data to determine which patterns most correlate with the network being in a complaint or non-compliant state. According to some embodiments, the network can operate within a trusted environment for a time so that analytics module 124 can establish baseline normalcy. According to some embodiments, analytics module 124 contains a database of norms and expectations for various components. This database can incorporate data from sources external to the network. Analytics module 124 can then create network security policies for how components can interact. According to some embodiments, when policies are determined external to network traffic monitoring system 100, analytics module 124 can detect the policies and incorporate them into this framework. A network administrator can manually tweak the network security policies. For example, network security policies can be dynamically changed and be conditional on events. These policies can be enforced on the components. Policy engine 126 can maintain these network security policies and receive user input to change the policies.

Policy engine 126 can configure analytics module 126 to establish what network security policies exist or should be maintained. For example, policy engine 126 may specify that certain machines should not intercommunicate or that certain ports are restricted. A network policy controller can set the parameters of policy engine 126. According to some embodiments, policy engine 126 is accessible via presentation module 128.

Over time, components may occasionally exhibit anomalous behavior. Analytics module 124 can analyze the frequency and severity of the anomalous behavior to determine a reputation score for the component. Analytics module 124 can use the reputation score of a component to selectively enforce security policies. For example, if a component has a high reputation score, analytics module 124 may allow the component to periodically violate its relevant policy; while if the component frequently violates its relevant policy, its reputation score may be lowered. Analytics module 124 can correlate observed reputation score with characteristics of a component. For example, a particular virtual machine with a particular configuration may be more prone to misconfiguration and receive a lower reputation score. According to some embodiments, security policies are strictly followed, but explicitly factor in a component's reputation score. When a new component is placed in the network, analytics module 124 can assign a starting reputation score similar to the scores of similarly configured components. The expected reputation score for a given component configuration can be externally sourced outside of the datacenter. A network administrator can be presented with expected reputation scores for various components before installation, thus assisting the network administrator in choosing components and configurations that will result in high reputation scores.

Some anomalous behavior can be indicative of a misconfigured component or a malicious attack. Certain attacks are easy to detect if they originate from outside of the datacenter, but can prove difficult to detect and isolate if they originate from within the datacenter. One such attack could be a distributed denial of service (DDOS) where a component or group of components attempt to overwhelm another component with spurious transmissions and requests. Detecting an attack or other anomalous network traffic can be accomplished by comparing the expected network conditions with actual network conditions. For example, if a traffic flow varies from its historical signature (packet size, TCP header options, etc.) it may be an attack.

Once potentially harmful traffic is identified, analytics module 124 can enforce and modify policies in order to mitigate the effects of the traffic. For example, a virtual machine may be prevented from communicating on certain ports. Analytics module 124 can use the sensors 104 to enforce these policies, including restarting a component. For example, if analytics module 124 determines that an individual process is causing the attack, it can direct the sensor located on that virtual machine to terminate or restart the process. This enables other processes on the virtual machine and other network components to continue normal operation without interruption.

According to some embodiments, analytics module 124 can simulate changes in the network. For example, analytics module 124 can simulate what may result if a new security policy is implemented, an end point such as a machine is taken offline or added, or a connection is severed or added. Historical ground truth flows can be used to simulate network traffic based on policy or EPG membership changes. This type of simulation can provide a network administrator with greater information on what policies to implement. According to some embodiments, the simulation may serve as a feedback loop for security policies. For example, if change to certain policies or new policies (e.g., and/or EPG membership changes) would affect certain services (as predicted by the simulation), those changes to the policies or new policies (and/or EPG membership changes) should not be implemented. As such, analytics module 124 can use simulations to discover vulnerabilities in the datacenter. According to some embodiments, analytics module 124 can determine which services and components will be affected by a change in security policies and/or EPG membership changes. Analytics module 124 can then take necessary actions to prepare those services and components for the change. For example, analytic module 124 can reject implementing the new policies and/or EPG membership changes. For example, network traffic monitoring system 100 can send a notification to administrators to initiate a migration of the components, or shut the components down, etc.

According to some embodiments, analytics module 124 can supplement its simulation analysis by initiating synthetic traffic flows and synthetic attacks on the datacenter. These artificial actions can assist analytics module 124 in gathering data to enhance its model. In some embodiments, these synthetic flows and synthetic attacks are used to verify the integrity of sensors 104, collectors 108, and analytics module 110. In some embodiments, the impact on an application due to changes to EPG membership can be determined and/or the impact of future attacks due to changes to EPG membership can be determined.

In some cases, when a traffic flow is expected to be reported by a sensor but fails to report it, it can be an indication that the sensor has failed or become compromised. Further, by comparing the network traffic flow data from multiple sensors 104 throughout the datacenter, analytics module 124 can determine if a certain sensor has failed to report a particular traffic flow.

Presentation module 128 can comprise serving layer 130, public alert 132, authentication 134, web frontend (FE)/UI 136 and 3^{rd} party tools 138. As analytics module 124 processes the data and generates network traffic flow data, they may not be in a human-readable form or they may be too large for an administrator to navigate. Presentation module 128 can take the network traffic flow data generated by analytics module 124 and further summarize, filter, and organize the network traffic flow data as well as create intuitive presentations of the network traffic flow data.

Serving layer 130 can be the interface between presentation module 128 and analytics module 124. As analytics module 124 generates network traffic flow data, predictions, and conclusions, serving layer 130 can summarize, filter, and organize the information that comes from analytics module 124. According to some embodiments, serving layer 139 can request raw data from a sensor, collector, or analytics module 124.

Web FE/UI 136 can connect with serving layer 130 to present the data from serving layer 130 in a page for human presentation. For example, web FE/UI 136 can present the data in bar charts, core charts, tree maps, acyclic dependency maps, line graphs, tables, etc. Web FE/UI 136 can be configured to allow a user to “drill down” on information sets to get a filtered data representation specific to the item the user wishes to “drill down” to. For example, individual traffic flows, components, etc. Web FE/UI 136 can also be configured to allow a user to filter by search. This search filter can use natural language processing to determine analyze the network administrator's input. There can be options to view data relative to the current second, minute, hour, day, etc. Web FE/UI 136 can allow a network administrator to view traffic flows, application dependency maps, network topology, etc.

According to some embodiments, web FE/UI 136 is solely configured to present information. According to some embodiments, web FE/UI 136 can receive inputs from a network administrator to configure network traffic monitoring system 100 or components of the datacenter. These instructions can be passed through serving layer 130, sent to configuration and image manager 102, or sent to policy engine 126. Authentication module 134 can verify the identity and privileges of the network administrator. In some embodiments, authentication module 134 can grant network administrators different rights according to established policies.

Public alert 132 is a module that can identify network conditions satisfying specified criteria and pushing alerts to third party tools 138. Public alert 132 can use network traffic flow data generated or accessible through analytics module 124. One example of third party tools 138 is a security information and event management system. Third party tools 138 may retrieve information from serving layer 130 through an API.

Additionally, the various elements of network traffic monitoring system 100 can exist in various configurations. For example, collectors 122 can be a component of sensors 104. In some embodiments, additional elements can share certain portion of computation to case the load of analytics module 124.

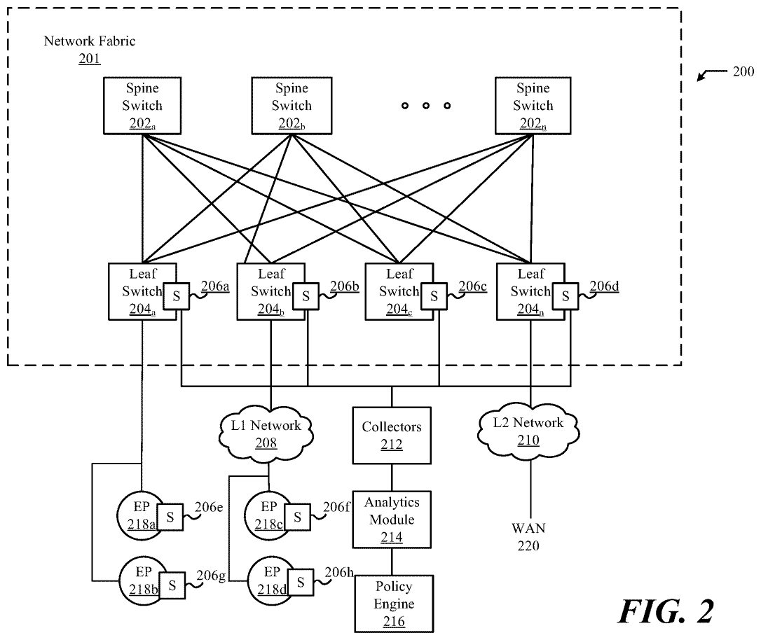

FIG. 2 illustrates an example of a network environment 200 for a network fabric adopting a leaf-spine architecture, according to some embodiments. Network fabric 201 can include spine switches 202ₐ, 202_{b}, . . . , 202ₙ (collectively, “202”) connected to leaf switches 204ₐ, 204_{b}, 204_{c}, . . . , 204ₙ (collectively “204”). Leaf switches 204 can include access ports (or non-fabric ports) and fabric ports. Fabric ports can provide uplinks to the spine switches 202, while access ports can provide connectivity for devices, hosts, end points, VMs, or external networks to network fabric 201. Although a leaf-spine architecture is illustrated in network fabric 201, one of ordinary skill in the art will readily recognize that the subject technology can be implemented based on any network fabric, including any data center or cloud network fabric. Indeed, other architectures, designs, infrastructures, and variations are contemplated herein.

Spine switches 202 can support various capabilities, such as 40 or 10 Gbps Ethernet speeds. Spine switches 202 can include one or more 40 Gigabit Ethernet ports, each of which can also be split to support other speeds. For example, a 40 Gigabit Ethernet port can be split into four 10 Gigabit Ethernet ports.

Leaf switches 204 can reside at the edge of network fabric 201, thus representing the physical network edge. According to some embodiments, the leaf switches 204 can be top-of-rack switches configured according to a top-of-rack architecture. According to some embodiments, the leaf switches 204 can be aggregation switches in any particular topology, such as end-of-row or middle-of-row topologies. The leaf switches 204 can also represent aggregation switches.

Leaf switches 204 can be responsible for routing and/or bridging the tenant packets and applying network policies. According to some embodiments, a leaf switch can perform one or more additional functions, such as implementing a mapping cache, sending packets to the proxy function when there is a miss in the cache, encapsulate packets, enforce ingress or egress policies, etc.

Network connectivity in network fabric 201 can flow through the leaf switches 204. For example, leaf switches 204 can provide servers, resources, endpoints, external networks, or VMs network access to network fabric 201. According to some embodiments, leaf switches 204 can connect one or more end point groups to network fabric 201 or any external networks. Each end point group can connect to network fabric 201 via one of leaf switches 204.

Endpoints 218ₐ-218_{d} (collectively “218”) can connect to network fabric 201 via leaf switches 204. For example, endpoints 218ₐ and 218_{b} can connect directly to leaf switch 204A. On the other hand, endpoints 218_{c} and 218_{d} can connect to leaf switch 204_{b} via L1 network 208. Similarly, wide area network (WAN) 220 can connect to leaf switches 204ₙ via L2 network 210.

Endpoints 218 can include any communication device or component, such as a computer, server, blade, hypervisor, virtual machine, container, process (e.g., running on a virtual machine), switch, router, gateway, etc. According to some embodiments, endpoints 218 can include a server, hypervisor, process, or switch configured with a VTEP functionality which connects an overlay network with network fabric 201. The overlay network can host physical devices, such as servers, applications, EPGs, virtual segments, virtual workloads, etc. In addition, endpoints 218 can host virtual workload(s), clusters, and applications or services, which can connect with network fabric 201 or any other device or network, including an external network. For example, one or more endpoints 218 can host, or connect to, a cluster of load balancers or an end point group of various applications.

Sensors 206ₐ-206ₕ (collectively “206) can be associated with each node and component of a data center (e.g., virtual machine, hypervisor, slice, blade, switch, router, gateway, etc.). As illustrated in FIG. 2, sensors 206 can be respectively associated with leaf switches 204 and endpoints 218. Sensors 206 can monitor communications to and from the component, report on environmental data related to the component (e.g., component IDs, statuses, etc.), and perform actions related to the component (e.g., shut down a process, block ports, redirect traffic, etc.). Sensors 104 can send these data to the collectors 212 for storage.

Sensors 206 can preprocess network traffic flow data before sending. For example, sensors 206 can remove extraneous or duplicative data or create a summary of the data (e.g., latency, packets and bytes sent per traffic flow, flagging abnormal activity, etc.). According to some embodiments, sensors 206 are configured to selectively capture certain types of connection information while disregarding the rest. Further, as it can be overwhelming for a system to capture every packet, sensors can be configured to capture only a representative sample of packets (for example, every 1,000th packet).

According to some embodiments, sensors 206 can perform various actions with regard to the associated network component. For example, a sensor installed on a VM can close, quarantine, restart, or throttle a process executing on the VM. Sensors 206 can create and enforce security policies (e.g., block access to ports, protocols, or addresses). According to some embodiments, sensors 206 receive instructions to perform such actions; alternatively, sensors 104 can act autonomously without external direction.

Sensors 206 can send network traffic flow data to one or more collectors 212. Sensors 206 can be assigned to send network traffic flow data to a primary collector and a secondary collector. In some embodiments, sensors 206 are not assigned a collector, but determine an optimal collector through a discovery process. Sensors 206 can change a destination for the report if its environment changes. For example, if a certain collector experiences failure or if a sensor is migrated to a new location that is close to a different collector. According to some embodiments, sensors 206 send different network traffic flow data to different collectors. For example, sensors 206 can send a first report related to one type of process to a first collector, and send a second report related to another type of process to a second collector.

Collectors 212 can be any type of storage medium that can serve as a repository for the data recorded by the sensors. Collectors 212 can be connected to network fabric 201 via one or more network interfaces. Collectors 212 can be located near the end of row or elsewhere on or off premises. The placement of collectors 212 can be optimized according to various priorities such as network capacity, cost, and system responsiveness. Although collectors 122 are generally herein referred to as a plural noun, a single machine or cluster of machines are contemplated to be sufficient, especially for smaller datacenters. In some embodiments, collectors 122 serve as sensors 202 as well.

According to some embodiments, collectors 212 serve as network storage for network flow data. Additionally, collectors 212 can organize, summarize, and preprocess the collected data. For example, collectors 212 can tabulate how often packets of certain sizes or types are transmitted from different virtual machines. Collectors 212 can also characterize the traffic flows going to and from various network components. According to some embodiments, collectors 212 can match packets based on sequence numbers, thus identifying traffic flows as well as connection links.

Analytics module 214 can process and analyze the data stored in various collectors 212 to perform various tasks. According to some embodiments, can utilize analytics module 214 to automatically determine network topology. Using data provided from sensors 202, analytics module 214 can determine what type of devices exist on the network (brand and model of switches, gateways, machines, etc.), where they are physically located (e.g., latitude and longitude, building, datacenter, room, row, rack, machine, etc.), how they are interconnected (10 Gb Ethernet, fiber-optic, etc.), and what the strength of each connection is (bandwidth, latency, etc.). Furthermore, analytics module 214 can detect changes of network topology without the needed of further configuration.

Analytics module 214 can determine dependencies of components within the network. For example, if component A routinely sends data to component B, but component B never sends data to component A, then analytics module 214 can determine that component B is dependent on component A, but A is likely not dependent on component B. If, however, component B also sends data to component A, then they are likely interdependent. These components can be processes, virtual machines, hypervisors, VLANs, etc.

Using the determined component dependencies, analytics module 214 can then form a component (“application”) dependency map. This map can be instructive when analytics module 214 attempts to diagnose the root cause of a failure or when analytics module 214 attempts to predict what will happen if a proposed network security policy is implemented or an end point is added or taken offline (e.g., one or more EPG memberships are changed).

According to some embodiments, analytics module 214 uses machine learning techniques to identify which patterns are policy-compliant or unwanted or harmful. According to some embodiments, analytics module 214 contains a database of norms and expectations for various components. This database can incorporate data from sources external to the network. Using this database, analytics module 214 can then create network security policies for how components can interact. According to some embodiments, when policies are determined external but safe, analytics module 214 can detect the policies and incorporate them into this framework. A network administrator can manually tweak the network security policies. For example, network security policies can be dynamically changed and be conditional on events. These policies can be enforced on the components. Policy engine 216 can maintain these network security policies and receive user input to change the policies.

Policy engine 216 can configure analytics module 214 to establish what network security policies exist or should be maintained. For example, policy engine 216 may specify that certain machines should not intercommunicate or that certain ports are restricted. A network security policy controller can set the parameters of policy engine 216.

Analytics module 214 can analyze the frequency and severity of the anomalous behavior to determine a reputation score for the component. Analytics module 214 can use the reputation score of a component to selectively enforce security policies. For example, if a component has a high reputation score, analytics module 214 may allow the component to periodically violate its relevant policy; while if the component frequently violates its relevant policy, its reputation score may be lowered. Analytics module 214 can correlate observed reputation score with characteristics of a component. For example, a particular virtual machine with a particular configuration may be more prone to misconfiguration and receive a lower reputation score. When a new component is placed in the network, analytics module 214 can assign a starting reputation score similar to the scores of similarly configured components. The expected reputation score for a given component configuration can be externally sourced outside of the datacenter. A network administrator can be presented with expected reputation scores for various components before installation, thus assisting the network administrator in choosing components and configurations that will result in high reputation scores.

According to some embodiments, analytics module 214 can simulate policy changes in the network and/or EPG membership changes. For example, analytics module 214 can receive a request to simulate a new network security policy between a first endpoint group and a second endpoint group and/or to simulate an EPG membership change between a first endpoint group and a second endpoint group. Analytics module 214, by simulating the new network policy and/or by simulating the EPH membership change, determines simulated network flow data which is parallel and independent from ground truth network flow data between the two endpoint groups. For example, a network management system can determine whether to implement the new network security policy or EPG membership change based on the effects of the simulated network flow data. In particular, analytics module 214 can determine, by monitoring simulated network flow data collected by sensors, the simulated network flow causes a negative impact, e.g., failed packet transmission or slowed packet transmission, on the ground truth network flow. According to some embodiments, when a traffic flow is expected to be reported by a sensor but fails to report it, it can be an indication that the sensor has failed or become compromised. Further, by comparing the network traffic flow data from multiple sensors 206 throughout the datacenter, analytics module 214 can determine if a certain sensor has failed to report a particular traffic flow. Accordingly, the network management system can determine not to enforce the new network security policy or EPG membership change. Conversely, when the simulated network flow does not lead to a negative impact on the ground truth network flow, analytic module 214 can determine to enforce the new network security policy or EPH membership change in the network.

Further, analytics module 214 can simulate what may result if an end point such as a machine is taken offline or added, or a connection is severed or added (e.g., can simulate an EPG membership change). An EPG membership change can be simulated based son simulating the effects on network traffic based on implementation of an experimental set of EPGs. An EPG membership change (e.g., changing membership of EPG groups) can include adding new endpoints to an EPG, removing endpoints from an EPG, moving an endpoint from one EPG to another. This type of simulation can provide a network administrator with greater information on what policies and/or EPG membership changes to implement. According to some embodiments, the simulation may serve as a feedback loop for security policies. For example, if changes to certain policies or new policies (and/or EPG membership changes) would negatively affect certain services (as predicted by the simulation), those changes to the policies or new policies (or EPG membership) should not be implemented. As such, analytics module 214 can use simulations to discover vulnerabilities in the datacenter. According to some embodiments, analytics module 214 can determine which services and components will be affected by a change in security policies or EPG membership. A network administrator can then take necessary actions to prepare those services and components for the changes. For example, the network management system can reject implementing the new policies or EPG membership changes. For example, the network traffic monitoring system can send a notification to administrators to initiate a migration of the components, or shut the components down, etc.

According to some embodiments, analytics module 214 can supplement its simulation analysis by initiating synthetic traffic flows and synthetic attacks on the datacenter. This simulated network flow data can assist analytics module 214 to make more accurate determinations regarding network bandwidth utilization network attacks. In some embodiments, these synthetic flows and synthetic attacks can also be used to verify the integrity of sensors 206, collectors 212, and analytics module 214.

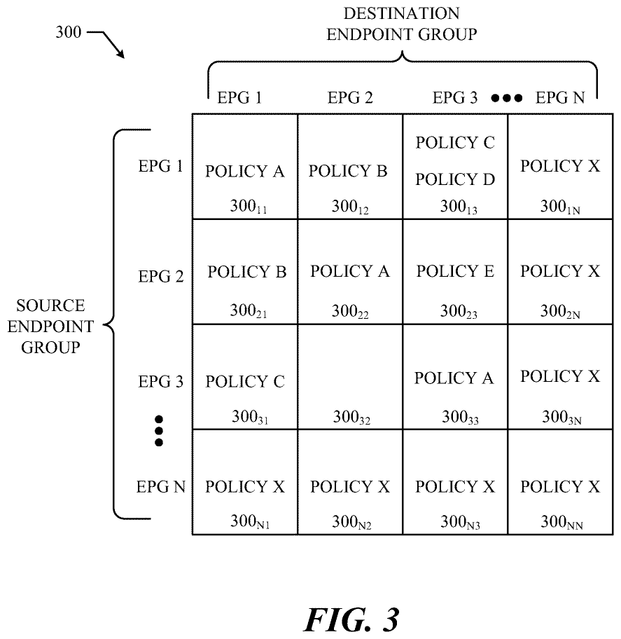

FIG. 3 illustrates an example of a policy table among endpoint groups, according to some embodiments. The matrix form in FIG. 3 is used for case of readability and to facilitate the understanding of how a policy table works. However, a policy table need not be stored in a matrix format or any particular type of data structure.

In policy table 300, each box lists the applicable policy or policies between a particular source endpoint group (SEPG) and a destination endpoint group (DEPG). Policy table 300 can include policies 300₁₁-300ₙₙ (collectively “300”) for enforcement in the network. In one example, the system can perform a lookup for SEPG=EPG 1 and DEPG=EPG 1 to determine the appropriate policy for a packet that is traveling from an endpoint that is part of EPG 1 to an endpoint that is also part of EPG 1. Accordingly, box 300₁₁ dictates that “Policy A” should be applied to traffic that travels from an endpoint that is part of EPG 1 to and an endpoint that is also part of EPG 1. Policy A may correspond to a policy that allows traffic to travel between the endpoints.

According to some embodiments, the same policies are applied in a bidirectional fashion. For example, box 300₁₂ provides for “Policy B” to be applied to traffic from EPG 1 to EPG 2, and box 300₂₁ provides for “Policy B” to also be applied to traffic from EPG 2 to EPG 1. Alternatively, policies can be applied differently for data that is going in one direction versus another. For example, box 300₁₃ provides for both “Policy C” and “Policy D” to be applied to traffic from EPG 1 to EPG 3 while box 300₃₁ provides only for “Policy C” to be applied to the data that travels in the opposite direction, from EPG 3 to EPG 1. Particularly, “Policy C” may be used to allow traffic to flow in both directions. However, “Policy D” may be used to change the quality of service (QOS) of the traffic in only one of the directions.

According to some embodiments, a network system can control data traffic by using a whitelist model in which a policy must be present to allow communication. A whitelist rule allows a communication while a blacklist rule blocks a communication. For example, box 300₃₂ defines the policies that govern traffic from EPG 3 to EPG 2. However, under a whitelist model, because this box does not contain any policies, traffic would not be allowed to flow from EPG 3 to EPG 2. Conversely, box 300₂₃ includes “Policy E” that governs traffic from EPG 2 to EPG 3. Hence, under a whitelist model, this example would allow unidirectional traffic from EPG 2 to EPG 3. Alternatively, a network can employ a blacklist model in which all traffic is permitted unless a particular policy exists to prevent it. According to some embodiments, the network system can convert a blacklist rule to a whitelist rule, using the dependency map as disclosed herein.

Enforcement of a security policy can include a number of actions such as allowing the traffic to continue, redirecting the traffic, changing the quality of service, or copying the data packet. In addition, the network system may also apply a tag to the data packet or set one or more bits in the data packet to mark the enforcement of the policy. Once the policy is applied, the appropriate network action can be performed on the data packet.

According to some embodiments, a network system can generate a simulation policy table that is configure to store one or more proposed network policies, which are subject to the policy simulation as described herein. For example, the network system, e.g., using an analytics module, can concurrently simulate multiple network policies, determine which proposed policies are proper to be implemented, and enforce these determined d policies throughout the network accordingly.

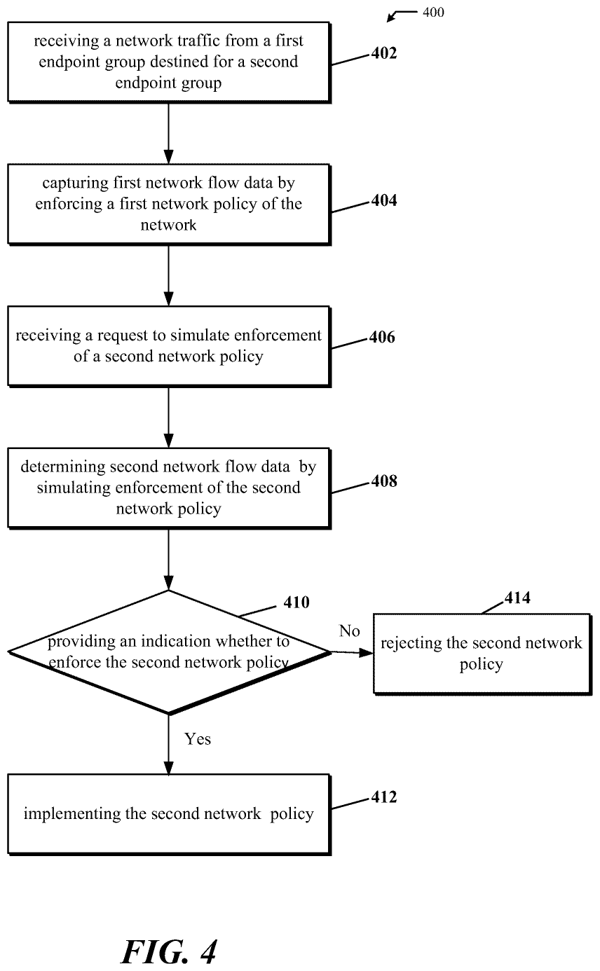

FIG. 4 is a flow diagram illustrating an example of a process 400 for a network traffic monitoring system, according to some embodiments. It should be understood that there can be additional, fewer, or alternative steps performed in similar or alternative orders, or in parallel, within the scope of the various embodiments unless otherwise stated.

At step 402, a network traffic monitoring system (e.g., network traffic monitoring system 200 of FIG. 2) can receive a network traffic from a first endpoint group destined for a second endpoint group. For example, as illustrated in FIG. 2, the network 200 can receive data packets sent from the first endpoint group associated with EP 218ₐ and destined for the second endpoint group associated with EP 218_{d}.

At step 404, the network traffic monitoring system can capture ground-truth network flow data between the first endpoint group and the second endpoint group by enforcing a first security policy stored in a policy table of a network. For example, as illustrated in FIG. 3, an ingress node of the network can perform a lookup for SEPG=EPG 1 and DEPG=EPG 1 to determine the appropriate policy for a packet that is traveling from an endpoint that is part of EPG 1 to an endpoint that is also part of EPG 1. Accordingly, box 300₁₁ dictates that “Policy A” should be applied to traffic that travels from an endpoint that is part of EPG 1 to and an endpoint that is also part of EPG 1. Policy A may correspond to a policy that allows traffic to travel between the endpoints.

At step 406, the network traffic monitoring system can receive a request to simulate a second network security policy between the first endpoint group and the second endpoint group of a network. For example, as illustrated in FIG. 2, analytics module 214 can receive a request to simulate a new network security policy between a first endpoint group and a second endpoint group.

At step 408, the network traffic monitoring system can determine second network flow data between the first endpoint group and the second endpoint group by simulating enforcement of the second network policy with respect to the network traffic. For example, analytics module 214, by enforcing the new network policy, determines simulated network flow data which can be parallel and independent from ground truth network flow data between the two endpoint groups.

At step 410, a network management system and/or network administrator can provide an indication whether to enforce the second network policy based at least in part on the second network flow data. For example, analytics module 214 can provide a recommendation whether to enforce the new network security policy based on the effects of the simulated network flow data and a confidence value for the recommendation. For example, the network administrator can determine whether the policy should be enforced based on analysis of the simulated network flow data and the recommendation and/or automate the network management system to enforce the policy if the confidence value is above a confidence threshold.

At step 412, the nodes of the network can implement the second network security policy. For example, when the simulated network flow does not lead to a negative impact on the ground truth network flow, the network management system and/or network administrator can determine to enforce the new network security policy in the network.

At step 414, the network traffic monitoring system can make a recommendation to reject the second network security policy. For example, when implementation of the second network policy exposes one or more endpoints to security threats or lowers a reputation value of one or more endpoints below a threshold, the network traffic monitoring system can recommend that the network policy should not be enforced.

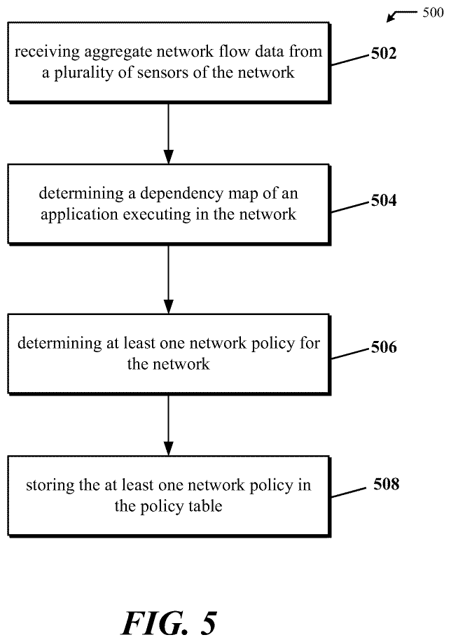

FIG. 5 is a flow diagram illustrating an example of another process 500 for a network traffic monitoring system, according to some embodiments. It should be understood that there can be additional, fewer, or alternative steps performed in similar or alternative orders, or in parallel, within the scope of the various embodiments unless otherwise stated.

At step 502, network traffic monitoring system 500 can receive aggregate network flow data from a plurality of sensors of the network. The plurality of sensors includes at least a first sensor of a physical switch of the network, a second sensor of a hypervisor associated with the physical switch, a third sensor of a virtual machine associated with the hypervisor. For example, as illustrated in FIG. 2, Sensors 206 can be associated with various nodes and components of a data center (e.g., virtual machine, hypervisor, slice, blade, switch, router, gateway, etc.). Sensors 206 can be respectively associated leaf switches, hypervisors, and virtual machines. Sensors 206 can monitor communications to and from the component, report on environmental data related to the component (e.g., component IDs, statuses, etc.), and perform actions related to the component (e.g., shut down a process, block ports, redirect traffic, etc.).

At step 504, network traffic monitoring system 500 can determine, based at least in part on the aggregate network flow data, a dependency map of an application executing in the network, the dependency map indicating a pattern of network traffic associated with the application. For example, analytics module 214 can determine dependencies of components within the network. For example, if component A routinely sends data to component B, but component B never sends data to component A, then analytics module 214 can determine that component B is dependent on component A, but A is likely not dependent on component B. If, however, component B also sends data to component A, then they are likely interdependent. These components can be processes, virtual machines, hypervisors, VLANs, etc. Using the determined component dependencies, analytics module 214 can then form a component (“application”) dependency map. This map can be instructive when analytics module 214 attempts to diagnose the root cause of a failure or when analytics module 214 attempts to predict what will happen if a proposed network security policy is implemented or an end point is added or taken offline.

At step 506, network traffic monitoring system 500 can determine, based at least in part on the dependency map, at least one network policy for the network. For example, analytics module 214 can use machine learning techniques to identify which patterns are policy-compliant or unwanted or harmful, thus deriving the related network security policies. According to some embodiments, analytics module 214 contains a database of norms and expectations for various components. This database can incorporate data from sources external to the network. Using this database, analytics module 214 can then create network security policies for how components can interact. According to some embodiments, when policies are determined external but safe, analytics module 214 can detect the policies and incorporate them into this framework. A network administrator can manually tweak the network security policies. For example, network security policies can be dynamically changed and be conditional on events.

At step 508, network traffic monitoring system 500 can store the at least one network policy in the policy table. For example, policy engine 216 can maintain these network security policies in a policy table. According to some embodiments, policy engine 216 can receive user input to change the policies.

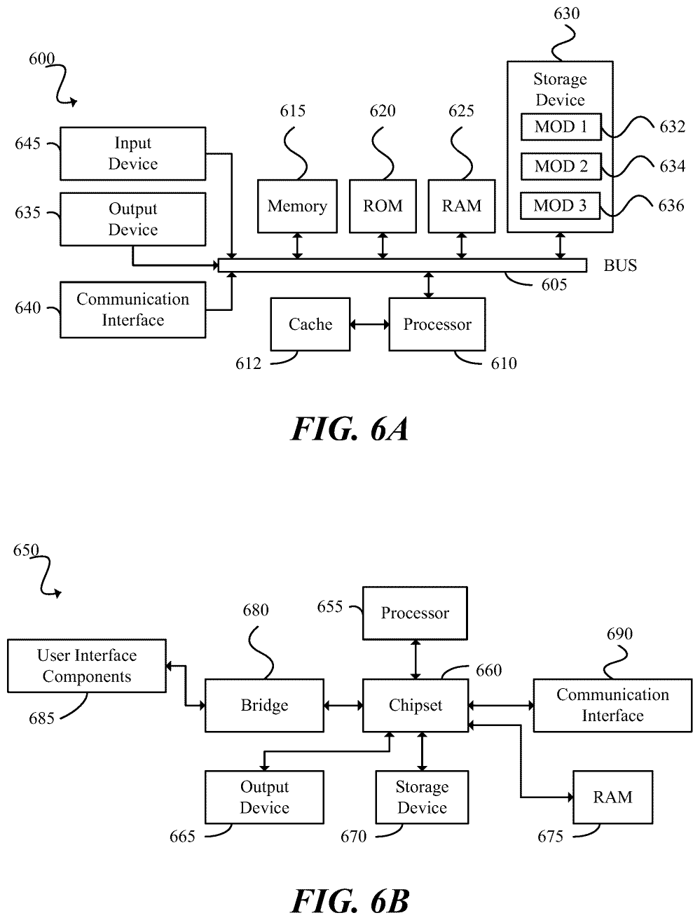

FIGS. 6A and 6B illustrate a computing platform of a computing device, according to some embodiments. FIG. 6A and FIG. 6B illustrate example system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Example system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, output device 635, and so forth, to carry out the function.

FIG. 6B illustrates an example computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that example systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A method comprising:
determining first network flow data by enforcing one or more network policies of a network on network traffic traveling from a first endpoint group (EPG) of the network to a second endpoint group of the network, wherein the first EPG includes a first plurality of endpoints associated with a first EPG membership and wherein the second EPG includes a second plurality of endpoints associated with a second EPG membership;
receiving a request to simulate enforcement of an EPG membership change associated with one or more of the first EPG and the second EPG;
determining second network flow data between the first EPG and an experimental set of endpoints included in the second EPG based on applying the EPG membership change and simulating enforcement of the one or more network policies with respect to the second network flow data while using the EPG membership change; and
providing an indication whether to enforce the EPG membership change based at least in part on the second network flow data.

2. The method of claim 1, wherein the indication is based at least in part on the first network flow data and the second network flow data.

3. The method of claim 1, further comprising:
receiving aggregate network flow data from a plurality of sensors of the network, the plurality of sensors including at least a first sensor of a physical switch of the network, a second sensor of a hypervisor associated with the physical switch, a third sensor of a virtual machine associated with the hypervisor;
determining, based at least in part on the aggregate network flow data, a dependency map of an application executing in the network, the dependency map indicating a pattern of network traffic associated with the application;
determining, based at least in part on the dependency map, at least one network policy for the network; and
storing the at least one network policy in a policy table.

4. The method of claim 3, wherein the at least one network policy comprises a whitelist rule.

5. The method of claim 3, wherein the at least one network policy comprises a blacklist rule, and the method further comprises:
converting, based at least in part on the dependency map, the blacklist rule to a whitelist rule.

6. The method of claim 3, further comprising:
simulating removal of at least one network policy from the policy table; and determining third network flow data without the at least one network policy in effect.

7. The method of claim 1, wherein the EPG membership change comprises addition of at least one endpoint to the first endpoint group or the second endpoint group.

8. The method of claim 1, wherein the EPG membership change comprises removal of at least one endpoint from the first endpoint group or the second endpoint group.

9. The method of claim 1, further comprising:
simulating membership of at least one endpoint in the first endpoint group to the second endpoint group; and
determining third network flow data associated with the at least one endpoint.

10. A system comprising:
one or more processors; and
memory including instructions that, upon being executed by the one or more processors, cause the system to:
determine first network flow data by enforcing one or more network policies of a network on network traffic traveling from a first endpoint group (EPG) of the network to a second endpoint group of the network, wherein the first EPG includes a first plurality of endpoints associated with a first EPG membership and wherein the second EPG includes a second plurality of endpoints associated with a second EPG membership;
receive a request to simulate enforcement of an EPG membership change associated with one or more of the first EPG and the second EPG;
determine second network flow data between the first EPG and an experimental set of endpoints included in the second EPG based on applying the EPG membership change and simulating enforcement of the one or more network policies with respect to the second network flow data while using the EPG membership change; and
provide an indication whether to enforce the EPG membership change based at least in part on the second network flow data.

11. The system of claim 10, wherein the indication is based at least in part on the first network flow data and the second network flow data.

12. The system of claim 10, wherein the instructions upon being executed further cause the system to:
receive aggregate network flow data from a plurality of sensors of the network, the plurality of sensors including at least a first sensor of a physical switch of the network, a second sensor of a hypervisor associated with the physical switch, a third sensor of a virtual machine associated with the hypervisor;
determine, based at least in part on the aggregate network flow data, a dependency map of an application executing in the network, the dependency map indicating a pattern of network traffic associated with the application;
determine, based at least in part on the dependency map, at least one network policy for the network; and
store the at least one network policy in a policy table.

13. The system of claim 12, wherein the at least one network policy comprises a whitelist rule.

14. The system of claim 12, wherein the at least one network policy comprises a blacklist rule, and wherein the instructions upon being executed further cause the system to:
convert, based at least in part on the dependency map, the blacklist rule to a whitelist rule.

15. The system of claim 12, wherein the instructions upon being executed further cause the system to:
simulating removal of at least one network policy from the policy table; and determining third network flow data without the at least one network policy in effect.

16. The system of claim 10, wherein the EPG membership change comprises addition of at least one endpoint to the first endpoint group or the second endpoint group.

17. The system of claim 10, wherein the EPG membership change comprises removal of at least one endpoint from the first endpoint group or the second endpoint group.

18. The system of claim 10, wherein the instructions upon being executed further cause the system to:
simulating membership of at least one endpoint in the first endpoint group to the second endpoint group; and
determining third network flow data associated with the at least one endpoint.

19. At least one non-transitory computer-readable medium including instructions that, upon being executed by one or more processors, cause the one or more processors to:
determine first network flow data by enforcing one or more network policies of a network on network traffic traveling from a first endpoint group (EPG) of the network to a second endpoint group of the network, wherein the first EPG includes a first plurality of endpoints associated with a first EPG membership and wherein the second EPG includes a second plurality of endpoints associated with a second EPG membership;
receive a request to simulate enforcement of an EPG membership change associated with one or more of the first EPG and the second EPG;
determine second network flow data between the first EPG and an experimental set of endpoints included in the second EPG based on applying the EPG membership change and simulating enforcement of the one or more network policies with respect to the second network flow data while using the EPG membership change; and
provide an indication whether to enforce the EPG membership change based at least in part on the second network flow data.

20. The at least one non-transitory computer-readable medium of claim 19, wherein the indication is based at least in part on the first network flow data and the second network flow data.
